(19) United States
(12) Patent Application Publication
(10) Pub. No.: US 2012/0131679 A1
(43) Pub. Date: May 24, 2012

(54) METHOD FOR PROTECTING SOFTWARE BASED ON CLOCK OF SECURITY DEVICE AND SECURITY DEVICE THEREOF

(76) Inventors: Zhou Lu, Beijing (CN); Huazhang Yu, Beijing (CN)

(21) Appl. No.: 12/989,679

(22) PCT Filed: Jul. 28, 2010
(86) PCT No.: PCT/CN10/75513

§ 371 Date: Oct. 26, 2010

(30) Foreign Application Priority Data
Apr. 28, 2010 (CN) 201010163373.2

(51) Int. Cl. G06F 21/00

(52) U.S. Cl. 726/26

(57) ABSTRACT

The invention discloses a software protecting method based on clock of a security device and a security device thereof. The method includes connecting to a terminal device to the security device, receiving the service instruction sent from protected software of the terminal device, protecting the protected software of the terminal device by the security device via the preset time protecting function. The security device includes an interface module and a control module. Thereby, the control module includes a communicating unit and a software protecting unit. The security device of the invention binds with functions such as time and date easily according to the time limit information which limits the time of using the security device and controls the start time and expiring time of using the security device accurately which provides safer service for protecting the software.

### FIELD OF THE INVENTION

The invention relates to information security field, and more particularly, relates to a method for protecting software based on clock of security device and security device thereof.

### BACKGROUND OF THE INVENTION

Security device is a small hardware device with processor and storage. The security device has inbuilt CPU, storage and chip operating system. With simple usability and low cost, the security device can store the key or digital certificate of the user and protect the software by using the algorithm stored in the security device.

In prior art, the popular way for protecting the accessing of software is by extracting the core algorithm or key from the software as the key code and storing the key code and the data needed by the key code in function module, for being called by external software, of a security device. That is, the function module is the code and/or data, for being called by the external software, extracted out by the software developer or stored in the security device already. Due to the method described above, in order to use software, the user must run the security device as well; otherwise, the user can not use the software.

The advantage of the method for protecting the software is that the key code is stored in the security device, which makes a hacker to obtain the key code of the software or clone the security device difficultly. So it is hard for illegal user to use the software. That is why more and more software developers adapt this method to protect their software.

However, There is weakness existing in the method for protecting the software in prior art. For example, the security device cannot record the start date of using the protected software and cannot control the time of using the protected software accurately as well.

### SUMMARY OF THE INVENTION

A method for protecting software based on clock of a security device, the method comprising

connecting, by a security device, to a terminal device;

receiving, by the security device, a service instruction sent from the terminal service;

protecting, by the security device, the protected software in the terminal device via the preset time protecting function.

A security device based on clock, wherein the security device comprising

an interface module, which is connected with a control module, adapted to connect the terminal device by the security device;

a control module adapted to control operations of the security device, wherein the control module comprises

a communicating unit, which is connected with the software protecting unit, adapted to communicate with the terminal device and receive the service instruction sent by the terminal device and return the corresponding result to the terminal device; and

a software protecting unit, which is connected with the communicating unit, adapted to protect the protected software in the terminal device via preset time protecting function.

### BRIEF DESCRIPTION OF THE DRAWINGS

FIG. 1 is a flow chart of a method for protecting software based on clock of a security device provided by Embodiment 1;

FIG. 2 is a flow chart of another method for protecting software based on clock of a security device provided by Embodiment 2;

FIG. 3 is a structural diagram illustrating of a security device provided by Embodiment 3;

FIG. 4 is a specific structural diagram illustrating of a security device provided by Embodiment 3;

FIG. 5 is another specific structural diagram illustrating of a security device provided by Embodiment 3;

FIG. 6 is a circuit diagram of a security device provided by Embodiment 3;

FIG. 7 is another structural diagram illustrating of a security device provided by Embodiment 4;

FIG. 8 is a flow chart of another method for protecting software based on clock of a security device provided by Embodiment 5;

FIG. 9 is a flow chart of another method for protecting software based on clock of a security device provided by Embodiment 6;

FIG. 10 is another structural diagram illustrating of a security device provided by Embodiment 7;

FIG. 11 is another specific structural diagram illustrating of a security device provided by Embodiment 7;

FIG. 12 is another specific structural diagram illustrating of a security device provided by Embodiment 7.

### DETAILED DESCRIPTION OF THE INVENTION

Objects, technical solutions and advantages of the invention will be easily understood by reference to the following description of embodiments when read in conjunction with the accompanying drawings.

### Embodiment 1

The embodiment provides a method for protecting software based on clock of a security device. Mostly, the clock of the security device, which is realized by clock chip, is hardware clock. In addition, the security device has cells that supply power to the security device when the security device is not connected with a terminal device.

In the embodiment, the hardware clock of a security device does not work according to the factory settings, which means that the hardware clock does not count time or calibrate time when the security device leaves the factory. Only if a service instruction from the terminal device is received, can the hardware clock start to count time. Furthermore, one or more pieces of time limit information can be set for the security device according to the factory settings. The time limit information is adapted to protect software with time protecting function after that the security device left the factory. In addition, only if the security device is connected with the terminal device and receives a service instruction from the terminal device, can the security device protect the software in a terminal device by using the time protecting function.

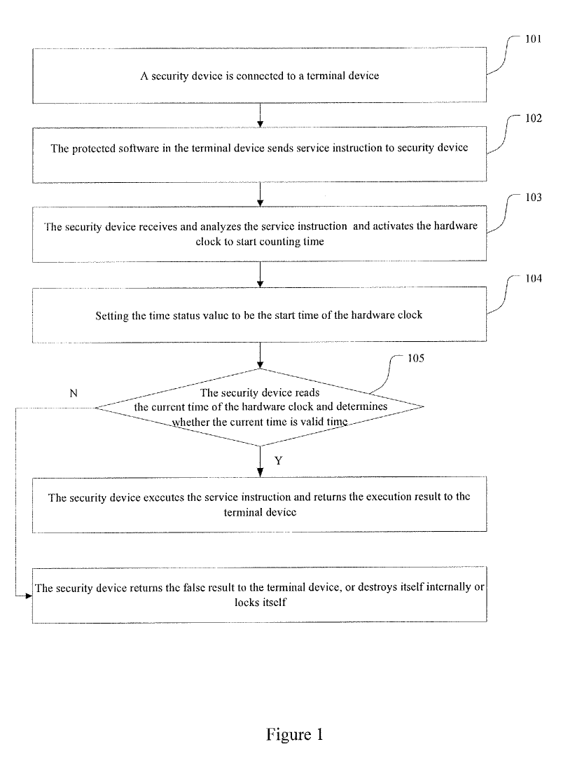

Referring to FIG. 1, a method for protecting software based on clock of a security device is as the follows:

Step 101, a security device is connected to a terminal device;

Specifically, step 101 includes:

powering up the security device;

performing enumerating operation on the security device by the terminal device to get the corresponding information of the security device;

sending a service instruction enclosed according to HID protocol to the security device by the terminal device and initializing the security device and communicating with the security device; or

sending a service instruction enclosed according to CCID protocol to the security device by the terminal device and initializing the security device and communicating with the security device; or

Sending a service instruction enclosed according to SSID protocol to the security device by the terminal device and initializing the security device and communicating with the security device;

The detail of the time limit information in the embodiment is permitting the protected software to use the security device with limited time length (for example, 10 hours);

The terminal device may be a computer, a card reader with power supply, RFID card reader or any device which can use the security device described above.

Step 102, the protected software in the terminal device sends service instruction to the security device; the service instruction is for activating a hardware clock and setting up the start time of the hardware clock, for example, the start time with 0X4D+60 bytes.

In the embodiment, the protected software refers to the software, of which part or all of the functions are modified or encrypted. In addition, the protected software can send service instruction to the security device automatically or the service instructions can be manually sent to the security device when the protected software starts protection function.

The service instruction is predetermined by the security device and the terminal device. It can be any one of plural predetermined instructions. For example, the service instruction can be an instruction for activating hardware clock and setting up start time of the clock, such as. start time with 0X4D+60 bytes; the service instruction also can be a communication instruction for the terminal device and the security device, such as APDU instruction 80 10 00 00 00; the service instruction also can be program start instruction and/or function algorithm instruction or reading instruction 0X3C, writing instruction 0X3D, etc.

Furthermore, the protected software of the terminal device can send encrypted service instructions to the security device. The encryption algorithm includes, but is not limited to, AES (Advanced Encryption Standard) or DES (Data Encryption Standard), etc.

Step 103, the security device receives and analyzes the service instruction sent from the terminal device and activates the hardware clock to start counting time;

In step 103, if the security device receives an encrypted service instruction, the security device will decrypt the service instruction according to the predetermined decryption algorithm which is but not limited to the algorithm such as AES or DES etc.

Step 104, the security device sets the time status value to be the start time of the hardware clock;

The time status value refers to the time value stored in the hardware clock before the hardware clock is activated to work;

And step 104 further includes that the security device reads the inside stored preset time limit information, which permits the protected software to use the security device with limited time length (for example, 10 hours), and determines whether the time status values saved in the hardware clock is 0;

if the time status value saved in the hardware clock is 0, the security device sets 10:00 as the expiring time of hardware clock for permitting the protected software to use the hardware clock,

if the time status value saved in the hardware clock is not 0, the security device sets the result, got by the current time status value plus the read time length (for example, 10 hours), as the expiring time of hardware clock for permitting the protected software to use the security device.

Thereby, if the security device determines that the time status value saved in the hardware clock is not 0, step 104 can include that the security device clears the time status value saved in the hardware clock to 0, and sets the start time of the hardware clock to be 0 and sets the read time length value as the expiring time of the hardware clock.

It should be noted that the embodiment of the invention omits the step of synchronizing process between the hardware clock of the security device and a clock of the terminal device. The security device can count time according to its hardware clock; meanwhile the security device may calibrate the current time of its hardware clock according to the clock of the terminal device via the received service instruction and then count time according to the calibrated time.

Step 105, the security device reads the current time of the hardware clock and determines whether the current time is valid time;

If so, the security device executes the service instruction and returns the executing result to the terminal device;

Otherwise, the security device returns false result to the terminal device, or destroys itself inside or locks itself automatically.

Thereby, the executing result or the false result returned by the security device may be encrypted. The encryption algorithm adapted by the security device can be but not limited to AES or DES; and the detail of the false result can be but not limited to prompt as that the security device is expired or error message or random result;

In step 105, specifically, that the security device determines whether the current time is valid time includes that

the security device calculates the differential value between the current time and the start time, compares the obtained differential value with the limited time length permitting the protected software to use the security device, and determines whether the obtained differential value overpasses the limited time length permitting the software to use the security device, if so, the current time is not valid; otherwise, the current time is valid;

For example, the current time of the hardware clock of the security device is 6:25 and the start time is 1:00; the limited time length permitting the protected software to use the security device is 10 hours. The differential value between the current time and the start time is 5 hours and 25 minutes, which does not overpass the limited time length, 10 hours. So the current time is valid;

Or, the security device reads the current time and expiring time of the hardware clock and determines whether the current time is before the expiring time, if so, the current time is valid; otherwise, the current time is not valid;

For example, the current time of the hardware of the security device is 10:45, while the expiring time is 10:00. The current time overpasses the expiring time, so that the current time is not valid.

In the embodiment, the process from step 103 to step 105 include that the security device fulfills time protecting function according to the time limit information and protects the software in the terminal device by using the preset time protecting function. The preset time protecting function is realized by the hardware clock in the embodiment.

It should be noted that once the security device protects the software in the terminal device by starting the preset time protecting function, the security device will not end the performing of the preset time protecting function unless the protected software stopped running by itself or the time is up to the expiring time. If the security device is forced to be stopped, the security device will be destroyed and the information that the security device is destroyed will be sent to the terminal device as well.

In the embodiment of the invention, the security device binds with functions such as time and date easily according to the time limit information which limits the time of using the security device and controls the start time and expiring time of using the security device accurately which provides safer service for protecting the software.

### Embodiment 2

The embodiment provides another method for protecting software based on a clock of a security device. Mostly, the clock of the security device realized by clock chip is a hardware clock. In addition, the security device has cells, which supply power to the security device when the security device is not connected to a terminal device.

In the embodiment, the hardware clock started working already and calibrated the time as well at the factory settings. Therefore, the time and date of the hardware clock is accurate and reliable. Furthermore, one or more pieces of time limit information are set up for the security device before the security device leaving the factory. The time limit information is adapted to perform time protecting function to the software by the time after that the security device leaves the factory. In addition, only if the security device is connected to the terminal device and receives a service instruction from the terminal device, can the security device protect the software in the terminal device by using the time protecting function described above.

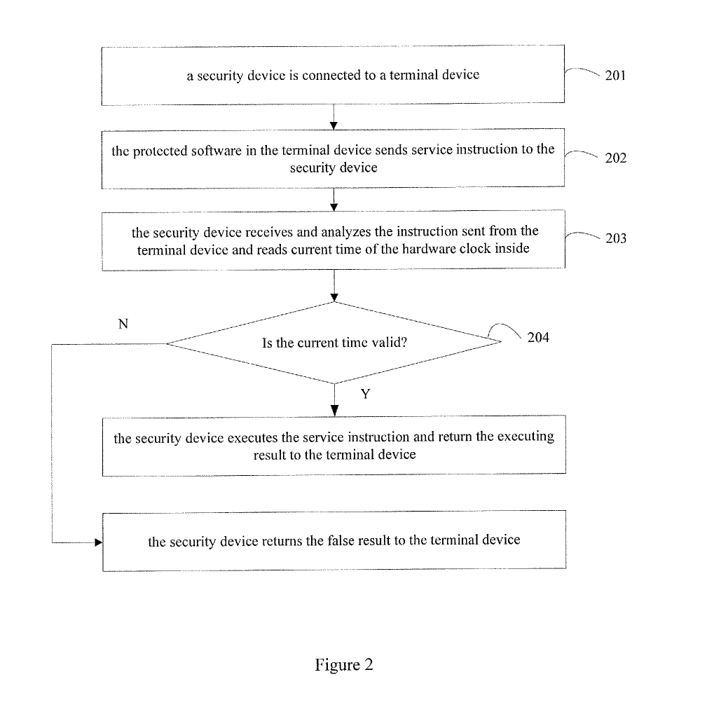

Referring to FIG. 2, a method for protecting software based on clock of a security device is as the follows:

Step 201, a security device is connected to a terminal device;

In the embodiment, the detail of step 201 is same with detail of step 101 in embodiment 1. No further description is given here;

Thereby, the time limit information in the embodiment can be permitting protected software to use the security device with limited time length (for example, 10 hours); or permitting the protected software to use the security device before an expiring date (for example, Dec. 31, 2010); or permitting the protected software to use the security device in special time period (for example, 8:00 a.m.-5:00 p.m. on some day).

Step 202, the protected software in the terminal device sends service instruction to the security device; thereby the service instruction can be instruction for reading current time of hardware clock, for example, 0X4C;

In the embodiment, the protected software refers to the software of which part or all of the functions are modified or encrypted. In addition, the protected software can send service instructions to the security device automatically or the service instructions can be artificially sent to the security device when the protected software starts protecting function.

The service instruction is predetermined by the security device and the terminal device. It can be any one of plural predetermined instructions. For example, the service instruction can be an instruction for reading current time of the hardware clock, such as 0X4C; the service instruction also can be communication instruction for the terminal device or the security device, such as APDU instruction 80 10 00 00 00; the service instruction also can be program start instruction and/or function algorithm instruction or reading instruction 0X3C, writing instruction 0X3D, etc.

Furthermore, the protected software stored in the terminal device can send encrypted service instructions to the security device. The encryption algorithm includes, but not limited to, AES (Advanced Encryption Standard) or DES (Data Encryption Standard), etc.

Step 203, the security device receives and analyzes the instruction sent from the terminal device and reads current time of the hardware clock inside;

It should be noted that the embodiment of the invention omits the step of synchronizing process between the hardware clock of the security device and clock of the terminal device. The security device counts time according to its hardware clock, meanwhile, the security device may calibrate the current time of its hardware clock according to the clock of the terminal device via the received service instruction and then count time according to the calibrated time.

Step 204, the security device determines whether the current time is valid;

If so, the security device executes the service instruction and returns the executing result to the terminal device;

Otherwise, the security device returns the false result to the terminal device.

Thereby, the executing result or the false result returned by the security device may be encrypted. The encryption algorithm adapted by the security device can be but not limited to AES or DES; and the details of the false result can be but not limited to prompt as that the security device is expired or error message or random result;

In step 204, the method for determining whether the current time is valid may be carried out in the following ways.

(1) if the time limit information is the time length permitting the protected software to use the security device,

Determining whether using the time protecting function of the security device is for the first time;

If so, saving the start time and time length of using the time protecting function of security device for the first time;

Otherwise, reading the saved time length of using the time protecting function of the security device and determining whether the value of the time length is smaller than that of the time length permitting the protected software to use the security device;

If so, the current time is valid;

Otherwise, the current time is not valid.

For example, if the saved time length of using the time protecting function of security device is 8 hours, while the time length permitting the protected software to use the security device is 10 hours, the current time is valid.

(2) If the time limit information is an expiring time for using the security device by the protected software;

The security device reads the current time of the hardware clock and the expiring time in the time limit information;

The security device determines whether the current time overpasses the expiring time;

If so, the current time is not valid;

Otherwise, the current time is valid.

(3) If the time limit information is for permitting the protected software to use the security device in specified time period,

The security device reads current time of the hardware clock, start time and expiring time in the time limit information;

The security device determines whether the current time is in the time interval between the start time and the expiring time;

If so, the current time is valid;

Otherwise, the current time is not valid.

For example, if the current time is 6:00 a.m., start time in the time limit information is 8:00 a.m. and expiring time in the time limit information is 5:00 p.m., the current time is not in the time interval between the start time and the expiring time. So the current time is not valid.

In the embodiment, step 203 and step 204 are steps that the security device performs preset time protecting function according to the time limit information by which the software in the terminal device is protected. The preset time protecting function is realized by the hardware clock;

It should be noted that once the security device protects the software in the terminal device by starting the preset time protecting function, the security device will not end the performing of the preset time protecting function unless the protected software stopped running by itself or the time is up to the expiring time. If the security device is forced to be stopped, the security device will be destroyed and the information that the security device is destroyed will be sent to the terminal device as well.

In the embodiment of the invention, the security device binds with functions such as time and date easily according to the time limit information which limits the time of using the security device and controls the start time and expiring time of using the security device accurately which provides safer service for protecting the software.

### Embodiment 3

The embodiment provides a security device of which the clock is realized by clock chip, specifically, a hardware clock. In addition, the security device has cells inside, which supply power for the hardware clock when the security device is not connected to a terminal device.

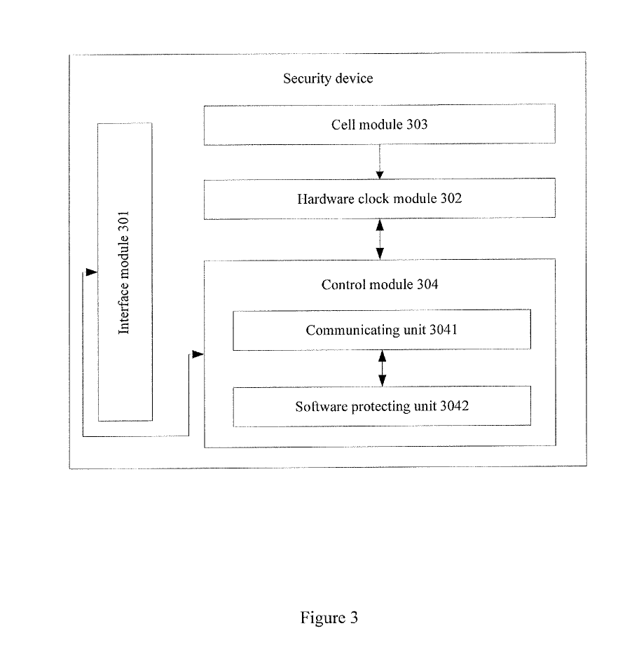

Referring to FIG. 3, the security device includes

an interface module 301, which is connected with Control module 304, adapted to build connection between the security device and the terminal device; specifically, the interface module 301 is a USB interface module in the embodiment;

a hardware clock module 302, which is connected with cell module 303 and Control module 304 respectively, adapted to count time and perform protection function for the software;

a cell module 303, which is connected with hardware clock module 302, adapted to supply power to the hardware clock module 302 when the security device is not connected with the terminal device;

a Control module 304 adapted to control operations of the security device;

wherein, the Control module 304 includes

a communicating unit 3041, which is connected with software protecting unit 3042, adapted to perform communication between the security device and the terminal device; specifically, adapted to receive predetermined service instruction sent from protected software in terminal device;

a software protecting unit 3042, which is connected with the communicating unit 3041, adapted for the security device to protect the protected software in the terminal device by using the preset time protecting function.

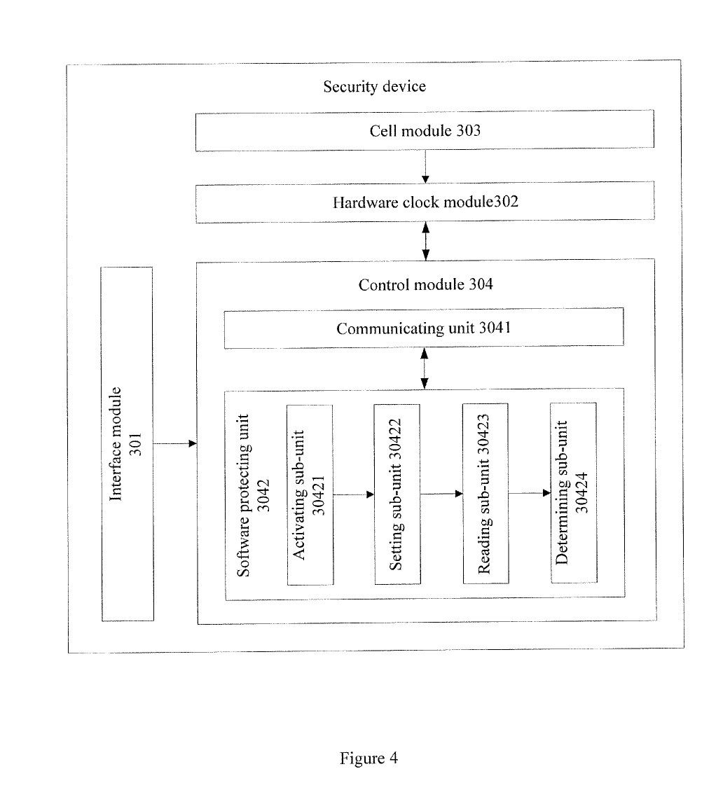

Furthermore, referring to FIG. 4, in one embodiment, the software protecting unit 3042 includes

an activating sub-unit 30421 adapted to activate the hardware clock module 302 in the security device to start counting time;

a setting sub-unit 30422, which is connected with the activating sub-unit 30421, adapted to set the time status value of the hardware clock module 302 to be the start time of the hardware clock module 302;

a reading sub-unit 30423, which is connected with the setting sub-unit 30422, adapted to read current time of the hardware clock module 302;

a determining sub-unit 30424, which is connected with the reading sub-unit 30423, adapted to determine whether the current time read by the reading sub-unit 30423 is valid;

Correspondingly, the communicating unit 3041 is further adapted to send the executing result of service instruction to the terminal device, when the determining sub-unit 30424 gets a positive result; adapted to send false result to the terminal device or make the security device to destroy itself inside or make the security device to lock itself; Thereby, the details of the false result can be but not limited to prompt as that the security device is expired or error message or random result.

Specifically, the setting sub-unit 30422 further is adapted to set the expiring time of hardware clock 302 according to the start time and the time limit information;

the reading sub-unit 30423 further is adapted to read the current time of the hardware clock module 302 and set the expiring time set by the setting sub-unit 30422;

Correspondingly, the determining sub-unit 30424 is adapted to determine whether the current time read by the reading sub-unit 30423 overpasses the expiring time;

if so, the determining sub-unit determines that the current time is not valid;

otherwise, the determining sub-unit determines that the current time is valid;

Or,

the reading sub-unit 30423 is adapted to read the current time of the hardware clock 302, the time limit information and the start time of the hardware clock module 302;

the determining sub-unit 30424 is adapted to determine whether the differential value between the current time and the start time is smaller than the time length value preset in the time limit information;

if so, the determining sub-unit determines that the current time is valid;

otherwise, the determining sub-unit determines that the current time is not valid.

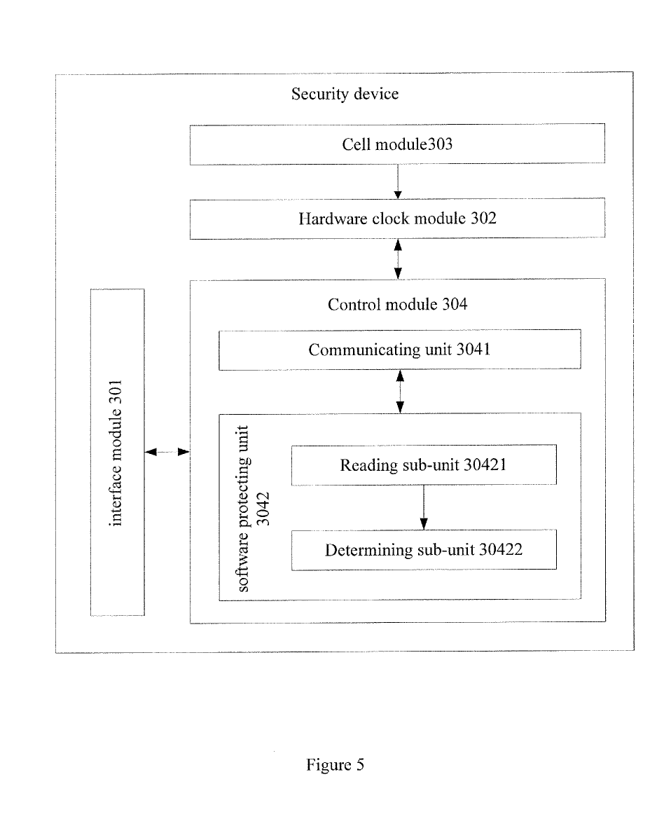

Furthermore, referring to FIG. 5, in another embodiment, the software protecting unit 3042 includes

a reading sub-unit 30421 adapted to read current time of hardware clock module 302;

a determining sub-unit 30422, which is connected with the reading sub-unit 30421, adapted to determine whether the current time read by the reading sub-unit 30421 is valid;

correspondingly, the communicating unit 3041 further adapted to send the executing result of service instruction to the terminal device, when the determining sub-unit 30424 gets a positive result; adapted to send false result to the terminal device or make the security device to destroy itself internally or make the security device to lock itself; Thereby, the details of the false result can be but not limited to prompt as that the security device is expired or error message or random result.

Specifically, the determining sub-unit 30422 is further adapted to determine whether time protecting function of the security device is started for the first time;

If so, the software protecting unit 3042 further includes a storage sub-unit adapted to store the time length of using the time protecting function of the security device for the first time;

Otherwise, the determining sub-unit 30422 is further adapted to determine whether the value of the time length of using the time protecting function of the security device for the first time is smaller than that of the preset time length permitting the protected software to use the time length of the security device;

If so, the current time is valid,

Otherwise, the current time is not valid;

or,

the reading sub-unit 30421 adapted to read current time of hardware clock module 302, time limit information and the time status value set to be the start time of the hardware clock module 302;

the determining sub-unit 30422 adapted to determine whether the differential value between the current time and the start time is smaller than the value of time length set in the time limit information;

if so, to determine that the current time is valid,

otherwise, to determine that the current time is not valid;

or

the reading sub-unit 30421 adapted to read current time of hardware clock module 302 and time limit information;

the determining sub-unit 30422 adapted to determine whether the current time overpasses the expiring time set in the time limit information;

if so, to determine that the current time is not valid,

otherwise, to determine that the current time is valid;

or

the reading sub-unit 30421 is adapted to read current time of hardware clock module 302 and time limit information;

the determining sub-unit 30422 is adapted to determine whether the current time of the hardware clock module 302 is in the specified time interval of using the security device in the time limit information;

if so, the current time is valid;

otherwise, the current time is not valid.

Furthermore, the control module 304 can further include

a decrypting unit adapted to decrypt the service instruction with the preset decryption algorithm when the communicating unit 3041 receives encrypted service instruction;

an encrypting unit adapted to encrypt the executing result or false result;

correspondingly, the communicating unit 3041 further adapted to return the encrypted executing result or the false result to the terminal device.

In the embodiment of the invention, the security device binds with functions such as time and date easily according to the time limit information which limits the time of using the security device and controls the start time and expiring time of using the security device accurately, which provides safer service for protecting the software.

Furthermore, detail about the function modules in the security device is given combined with a circuit diagram.

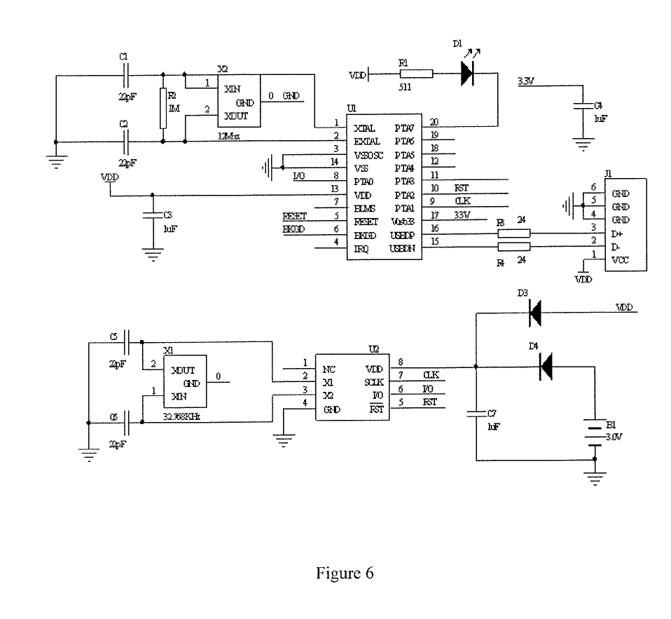

Referring to FIG. 6, it shows a circuit diagram of the security device provided by the embodiment of the invention. J1 in FIG. 6 corresponded to the interface module of the security device, specifically, is a USB interface and adapted to connect the security device and the terminal device. Specifically, the hardware clock module in the security device is made up by U2, X1, C5 and C6 in FIG. 6. B1 in FIG. 6 represents cells. The cell module of the security device, which is made up by B1, C7, D3 and D4 in FIG. 6, supplies power to the hardware clock module in the security device. U1 in FIG. 6 is a CPU chip. The functions of the communicating module and the start module are integrated on the CPU chip.

### Embodiment 4

The embodiment provides another security device based on clock. The clock in the security device is realized by software clock. That is, the CPU chip of the security device has a timer that works independently. The timer keeps working even if the CPU chip stops working.

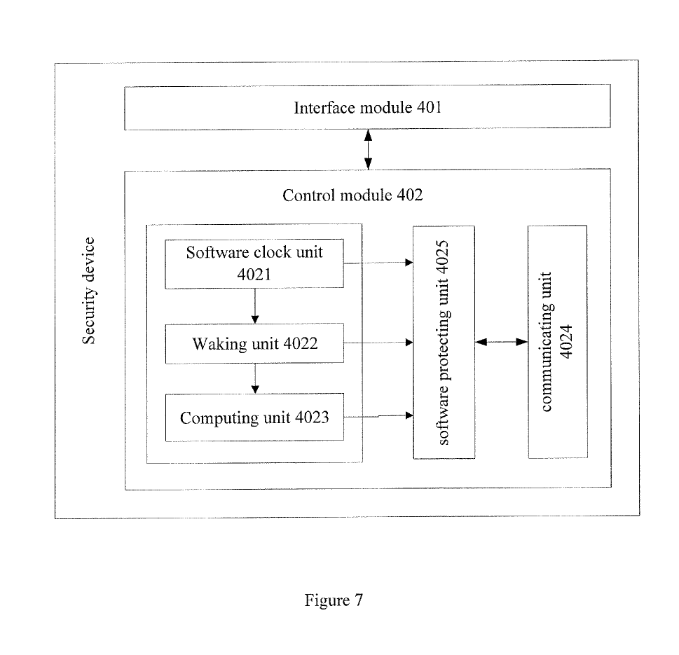

Referring to FIG. 7, the security device includes

an interface module 401, which is connected with control module 402, adapted to build connection between the security device and the terminal device; specifically, the interface module 401 is a USB interface module in the embodiment;

a control module 402 adapted to control operations of the security device;

Thereby, the control module 402 includes

a software clock unit 4021 adapted to count time and realize time protecting function of the security device;

In the embodiment, the cycle time of the software clock unit 4021 can be 1 second. The software clock unit 4021 keeps counting time even if the security device stops working. The software clock unit 4021 starts counting time and a waking unit wakes a computing unit to start work regularly according to the preset cycle time, which is 1 second;

a waking unit 4022, which is connected with the software clock unit 4021, adapted to wake computing unit 4023 to work over the time period, specifically, to wake computing unit 4023 to start work by interruption.

a computing unit 4023, which is connected with the software clock unit 4021 and the waking unit 4022 respectively, adapted to add the value of cycle time of the software clock unit to the value of the time when the security device stops working to get the new value, and set the new value as the new current time;

In the embodiment, the security device stopped working at 13:21:59 on Mar. 17, 2010. But the software clock keeps counting time. After 1 second, the waking unit wakes up the computing unit to add 1 second to the time when the security device stops working, which is 13:21:59 on Mar. 17, 2010. So the current time of the security device is 13:22:00 on Mar. 17, 2010. So the time of the security device keeps updating even if the security device does not work. As the time counted as described above, the time is accurate and reliable.

a communicating unit 4024, which is connected with software protecting unit 4025, adapted to communicate with the security device;

a software protecting unit 4025, which is connected with the software clock unit 4021, the waking unit 4022, the computing unit 4023 and the communicating unit 4024, adapted for the security device to protect the software in the terminal device by using the preset time protecting function.

In the embodiment, the control module 402 further includes an encrypting unit and a decrypting unit, of which functions are same with those of the encrypting unit and the decrypting unit described in Embodiment 3. No further description is given here.

Correspondingly, the operation of communicating unit 4024 and the software protecting unit 4025 is same with that of what described in Embodiment 3. No further description is given here.

In addition, the process of the method for protecting software based on clock of a security device is same with the process described in Embodiment 1 and Embodiment 2. No further description is given here.

In the embodiment of the invention, the security device binds with functions such as time and date easily according to the time limit information which limits the time of using the security device and controls the start time and expiring time of using the security device accurately which provides safer service for protecting the software.

### Embodiment 5

The embodiment provides another method for protecting software based on clock of a security device. The clock of the security device is realized by a timer inside. The CPU chip of the security device has a timer that depends on the CPU chip when working. And the security device has function module that includes code and/or data that are exacted from the protected software and can be called externally.

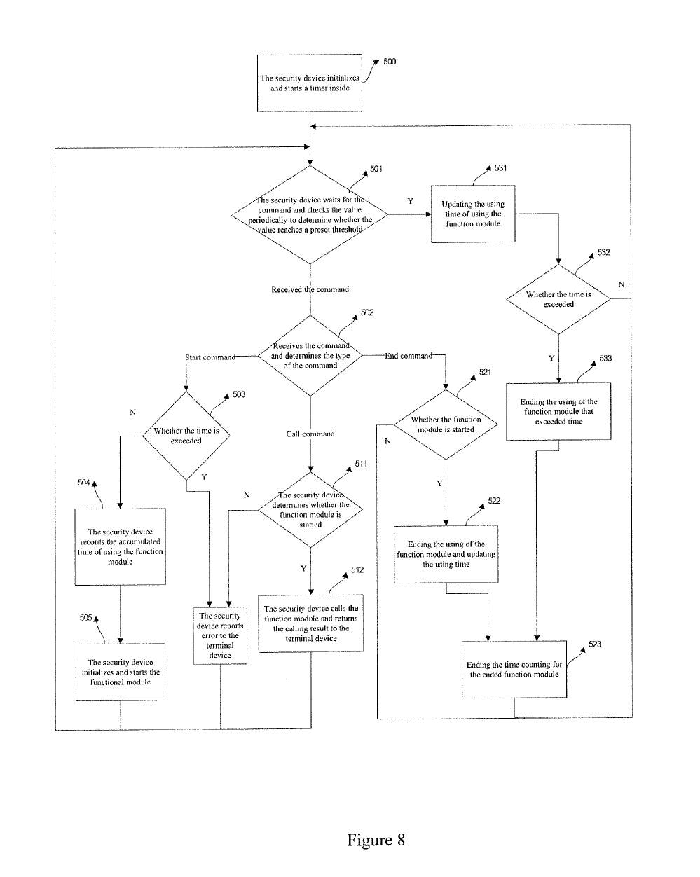

Referring to FIG. 8, the embodiment provides another method for protecting software based on clock of a security device. After the security device is connected to a terminal device, the process includes that

Step 500, the security device initializes and starts a timer inside;

In step 500, that the security device initializes and starts a timer inside includes setting up the initial time of the timer inside and starting the timer inside to perform software protection function.

Step 501, the security device waits for the command from the terminal device and checks the value of the timer inside periodically to determine whether the value reaches a preset threshold value, if so, go to step 531; otherwise, go to step 502;

Step 502, the security device receives the command from the terminal device and determines whether the received command is Start command, Call command or End command;

If the received command is Start command, go to step 503;

If the received command is Call command, go to step 511;

If the received command is End command, go to step 521;

Step 503, the security device determines whether the function module required to be started exceeds time, if so, sending error to the terminal device and going back to step 501; otherwise, go to step 504;

Alternatively, in step 503, if the function module exceeds time, no operation being performed and going back step 501 directly.

Step 504, the security device records the accumulated time of using the function module according to the output of the timer inside;

Step 505, the security device initializes and starts the functional module and then goes back to step 501;

Alternatively, Step 505 may be performed ahead of Step 504.

Step 511, the security device determines whether the function module is started, if so, go to step 512; otherwise, the security device reports error to the terminal device and goes back to step 501;

For the case that the function is not started yet in step 511, the security device goes back to step 501 directly without any operation.

Step 512, the security device calls the function module and returns the calling result to the terminal device and goes back step 501;

Step 521, the security device checks whether the function module is started, if so, go to step 522; otherwise, going back step 501;

Step 522, the security device ends the using of the function module and updates the time of using the function module.

Step 523, the security device ends the time counting for the ended function module and goes back step 501;

Ending the using of the function module includes step 522 and step 523, which performs ending the time counting and updating the using time. Thereby, when the function module is ended, the time counting for using the function module should be ended and the time of using the function module should be updated.

Step 531, updating the using time of using the function module;

Step 532, checking and determining whether the function module exceeds time, if so, go to step 533; otherwise, go to step 501;

Step 533, ending the using of the function module that exceeded time, then go to step 523.

The cycle checking performed by the steps that from step 531 to 533 can be checking the time of using the function module at preset time interval regularly and updating the time of using the function module, which provides condition for checking whether the time of using the function module is exceed. The smaller the threshold value, the shorter the period for checking whether the time of using the function module, the higher sensitivity for control the security device; vice versa.

In the embodiment of the invention, the security device binds with functions such as time and date easily according to the time limit information which limits the time of using the security device and controls the start time and expiring time of using the security device accurately, which provides safer service for protecting the software.

### Embodiment 6

The embodiment provides another method for protecting software based on clock of a security device. The clock of the security device is realized by a timer inside. The CPU chip of the security device has a timer that depends on the CPU chip when working.

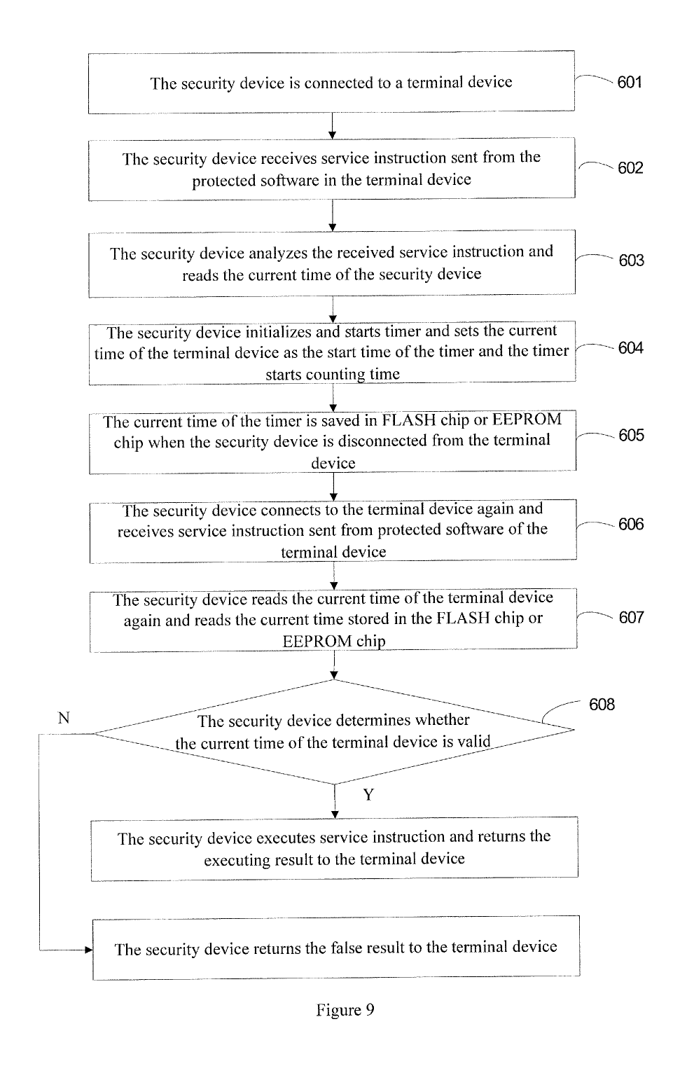

Referring to FIG. 9, the embodiment provides another method for protecting software based on clock of a security device, which includes that

Step 601, the security device is connected to a terminal device;

In the embodiment, the detail of step 601 is same with that of step 101 in embodiment 1; no description is repeated here.

Step 602, the security device receives service instruction sent from the protected software in the terminal device;

In step 602, the protected software refers to the software, of which part or all of the functions are modified or encrypted. In addition, the protected software can send service instruction to the security device automatically or the service instruction can be artificially sent to the security device when the protected software starts protection function.

The service instruction is predetermined by the security device and the terminal device. It can be any one of plural predetermined instructions. For example, the service instruction can be for reading current time of the terminal device; the service instruction also can be communication instruction for the terminal device and the security device, such as APDU instruction 80 10 00 00 00; the service instruction also can be program start instruction and/or function algorithm instruction or reading instruction 0X3C or writing instruction 0X3D, etc.

Furthermore, if the service instruction received by the security device is encrypted, the security device will decrypt the encrypted service instruction with predetermined decryption algorithm. The decryption algorithm can be, but not limited to, AES or DES, etc.

Step 603, the security device analyzes the received service instruction and reads the current time of the security device;

Step 604, the security device initializes and starts timer and sets the current time of the terminal device as the start time of the timer and the timer starts counting time;

In the embodiment, if the current time of the terminal device read in step 603 is 15:00 on Mar. 18, 2010, the start time of the time is set to be 15:00 on Mar. 18, 2010 and the timer starts to count time from then on.

Step 605, the current time of the timer is saved in FLASH chip or EEPROM chip when the security device is disconnected from the terminal device;

In the embodiment, when the security device is disconnected from the terminal device, the CPU chip of the security device can not work due to no power supply for the security device; correspondingly, the timer of the CPU chip stops counting time and the current time of the timer will be lost as well. That is why the security device stores the current time of the timer into the FLASH chip or EEPROM chip;

In the embodiment, the time that the timer starts counting is 15:00 on Mar. 18, 2010. If the security device disconnects from the terminal device 20 minutes after the timer starts counting time, the current time of the timer should be 15:20 on Mar. 18, 2010. So that the security device stores the current time of the timer, which is 15:20 on Mar. 18, 2010, into FLASH chip or EEPROM chip.

Step 606, the security device connects to the terminal device again and receives service instruction sent from protected software of the terminal device;

Step 607, the security device reads the current time of the terminal device again and reads the current time stored in the FLASH chip or EEPROM chip;

Step 608: the security device determines whether the current time of the terminal device is valid according to the time stored into the FLASH chip or EEPROM chip;

If so, the security device executes service instruction and returns the executing result to the terminal device;

Otherwise, the security device returns the false result to the terminal device; or the security device is destroyed by itself internally or the security device is locked by itself automatically.

In the embodiment, determining whether the current time of the terminal device is valid according to the time stored in the FLASH chip or EEPROM chip includes determining whether the current time of the terminal device is after the current time of the terminal device, if so, the current time is valid; otherwise, the current time is not valid;

If the executing result or false result returned by the security device to the terminal device is encrypted, the encryption algorithm adapted by the security device can be but not limited to AES or DES; and the false result can be but not limited to prompt as that the security device is expired or error message or random result;

For example, the current time of the security device read in step 607 is 17:00 on Mar. 18, 2010; the time stored in the FLASH chip or EEPROM chip is 15:20 on Mar. 18, 2010; it can be concluded that the current time of the terminal device is after the time stored in the FLASH chip or EEPROM chip; the security device will execute the service instruction and return the executing result to the terminal device;

For example, the current time of the security device read in step 607 is 11:40 on Mar. 18, 2010; the time stored in the FLASH chip or EEPROM chip is 15:20 on Mar. 18, 2010; it can be concluded that the current time of the terminal device is before the time stored on the FLASH chip or EEPROM chip; the security device will send the false result to the terminal device.

It should be noted that once the security device protects the software in the terminal device by starting the preset time protecting function, the security device will not end the performing of the preset time protecting function unless the protected software stopped running by itself or the time is up to the expiring time. If the security device is forced to be stopped, the security device will be destroyed and the information that the security device is destroyed will be sent to the terminal device as well.

In the embodiment of the invention, the security device binds with functions such as time and date easily according to the time limit information which limits the time of using the security device, controls the start time and expiring time of using the security device accurately which provides safer service for protecting the software.

### Embodiment 7

The embodiment provides a security device based on clock which is realized by a timer inside.

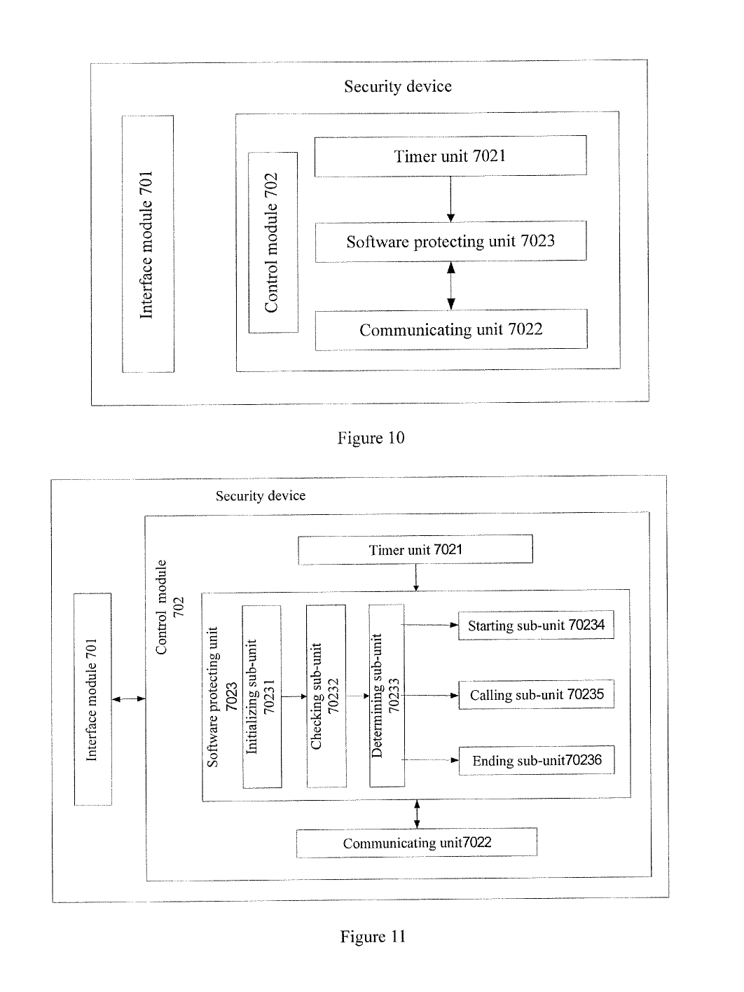

Referring to FIG. 10, the security device includes an interface module 701, which is connected with control module 702, adapted to build connection between the security device and a terminal device; specifically, the interface module can be a USB interface module;

a control module 702, adapted to control operations of the security device;

Thereby, the control module 702 includes

a timer unit 7021, which is connected with software protecting unit 7023, adapted to count time and realize protection function for the software;

a communicating unit 7022, which is connected with software protecting unit 7023, adapted to perform communication between the security device and the terminal device; specifically, adapted to receive command sent from the terminal device;

a software protecting unit 7023, which is connected with timer unit 7021 and communicating unit 7022 respectively, adapted for the security device to protect the software of the terminal device by the preset time protecting function.

Furthermore, referring to FIG. 11, in one embodiment, the software protecting unit 7023 includes

an initializing sub-unit 70231 adapted to initialize and start timer unit 7021 to start count time;

a checking sub-unit 70232, which is connected with initializing sub-unit 70231, adapted to check and determine whether the value of the timer reaches threshold when waiting for the command sent by the terminal device;

a determining sub-unit 70233, which is connected with checking sub-unit 70232, adapted to determine the type of the command sent from the terminal device;

a starting sub-unit 70234, which is connected with the determining sub-unit 70233, adapted to start function module when the determining sub-unit 70233 determines that the received command is Start command; the function module refers to the key code or data stored in the key device for the software of the terminal device to call when the software is performed.

a calling sub-unit 70235, which is connected with determining sub-unit 70233, adapted to start the function module when the determining sub-unit 70233 determines that the received command is Call command;

an ending sub-unit 70236, which is connected with determining sub-unit 70233, adapted to end the using of the function module when the determining sub-unit 70233 determines that the received command is End command.

Furthermore, when the checking sub-unit 70232 checks and determines that the value of the timer reaches threshold value, the control module 702 further includes

an updating unit adapted to update the time of using the function module;

correspondingly, the checking sub-unit 70232 further adapted to determine whether the function module exceeds time;

if the function module exceeds time, the ending unit 70236 further adapted to end the using of the function module and to end the time counting for the function module;

When the determining sub-unit 70233 determines that the command received is Start command, the determining sub-unit 70233 further adapted to determine whether the function module exceeds time;

If the function module does not exceed time, the control module 702 further includes

a recording unit adapted to record the time of using the function module according to the time of the timer unit 7021;

if the determining sub-unit 70233 determines that the received command is Call command, the determining sub-unit 70233 further adapted to determine whether the function module is started;

if the determining sub-unit 70233 determines that the received command is Stop command, the determining sub-unit 70233 further adapted to determine whether the function module is started.

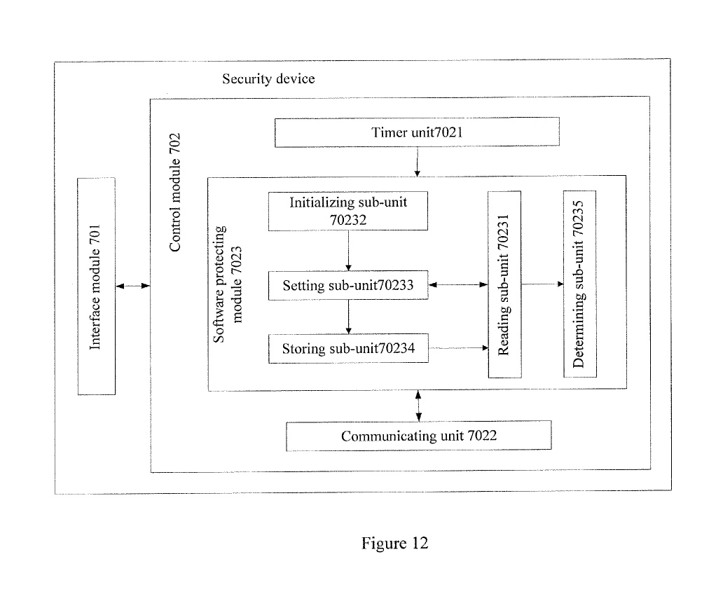

Furthermore, referring to FIG. 12, in another embodiment, software protecting unit 7023 includes

a reading sub-unit 70231 adapted to read current time of the terminal device;

an initializing sub-unit 70232 adapted to initialize and start timer unit 7021 to start counting time;

a setting sub-unit 70233, which is connected with the reading sub-unit 70231 and the initializing sub-unit 70232 respectively, adapted to set the current time of the terminal device, read by the reading 70231, as the start time of the timer unit 7021;

a storing sub-unit 70234, which is connected with the setting sub-unit 70233, adapted to store the current time of the timer unit 7021 in the non-volatile storage chip when power is off;

correspondingly, the communicating unit 7022 further adapted to receive service instruction sent form the protected software in the terminal device when the security device is connected with the terminal device again;

the reading sub-unit 70231, which is connected with the storing sub-unit 70234, adapted to read the current time of the terminal device and the time stored in the non-volatile storage chip;

a determining sub-unit 70235, which is connected with the reading sub-unit 70231, adapted to determine whether the current time of the terminal device is valid according to the time stored in the FLASH chip or EEPROM chip; specifically, adapted to determine whether the current time of the terminal device is after the time stored in the non-volatile storage chip.

Furthermore, the control module 702 further includes

a decrypting unit adapted to decrypt the encrypted service instruction with the predetermined decryption algorithm when the received instruction is encrypted;

an encrypting unit adapted to encrypt the executing result or false result;

correspondingly, the communicating unit 7022 further adapted to return the executing result and the false result to the terminal device.

In the embodiment of the invention, the security device binds with functions such as time and date easily according to the time limit information which limits the time of using the security device and controls the start time and expiring time of using the security device accurately which provides safer service for protecting the software.

The presently disclosed embodiments should be considered in all respects to be illustrative and not restrictive. The scope of the invention is indicated by the appended claims rather than the foregoing description, and all variations which come within the meaning and range of equivalents thereof are intended to be embraced therein.

1. A method for protecting software based on clock of a security device, the method comprising
connecting, by a security device, to a terminal device;
receiving, by the security device, a service instruction sent from the terminal service;
protecting, by the security device, the protected software in the terminal device via the preset time protecting function.

2. The method of claim 1, wherein the service instruction is predetermined by the security device and the terminal device, or the service instruction is any one of a plural of instructions predetermined by the security device and the terminal device.

3. The method of claim 1, wherein protecting, by the security device, the protected software in the terminal device via the preset time protecting function comprises protecting, by the security device, the protected software in the terminal device via a hardware clock, a software clock or a timer.

4. The method of claim 3, wherein protecting, by the security device, the protected software in the terminal device via a hardware clock comprising
activating, by the security device, a hardware clock inside to start counting time;
setting time status value of the hardware clock inside to be the start time of the hardware clock inside;
reading current time of the hardware clock inside and determining whether the current time is valid;
if the current time is valid, executing the service instruction and returning the executing result to the terminal device;
if the current time is not valid, returning false result to the terminal device, or destroying the security device by itself internally, or locking the security device by itself automatically; or
reading the current time of the hardware clock inside directly;
determining whether the current time is valid;
if the current time is valid, executing the service instruction and returning the executing result to the terminal device;
if the current time is not valid, returning false result to the terminal device, or destroying the security device by itself internally, or locking the security device automatically.

5. The method of claim 3, wherein protecting, by the security device, the protected software in the terminal device via a software clock comprises
activating, by the security device, a software clock inside to start counting time;
setting the time status value of the software clock inside to be the start time of the hardware clock inside;
reading current time of the software clock inside and determining whether the current time is valid;
if the current time is valid, executing the service instruction and returning the executing result to the terminal device;
if the current time is not valid, returning false result to the terminal device, or destroying the security device by itself internally, or locking the security device by itself automatically; or
reading the current time of the software clock inside directly;
determining whether the current time is valid;
if the current time is valid, executing the service instruction and returning the executing result to the terminal device;
if the current time is not valid, returning false result to the terminal device, or destroying the security device by itself internally, or locking the security device by itself automatically.

6. The method of claim 3, wherein protecting, by the security device, the protected software in the terminal device via a timer comprises
recording the accumulated time of using the function module of the security device via the timer;
controlling the using of the function module according to the service instruction received by the security device or the actual time of using function module; or
initializing and starting, by the security device, the timer, and setting the current time of the security device to be the start time of the timer and starting counting time by the time;
storing the current time of the timer into the non-volatile storage chip when power is off;
reading the current time of the terminal device and the time stored in the non-volatile storage chip;
determining whether the current time is valid according to the time stored in the non-volatile storage chip;
if the current time is valid, executing the service instruction and returning the executing result to the terminal device;
if the current time is not valid, returning false result to the terminal device, or destroying the security device by itself internally, or locking the security device by itself automatically.

7. A security device based on clock, wherein the security device comprising
an interface module, which is connected with a control module, adapted to connect the terminal device by the security device;
a control module adapted to control operations of the security device, wherein the control module comprises
a communicating unit, which is connected with the software protecting unit, adapted to communicate with the terminal device and receive the service instruction sent by the terminal device and return the corresponding result to the terminal device;
a software protecting unit, which is connected with the communicating unit, adapted to protect the protected software in the terminal device via preset time protecting function.

8. The security device of claim 7, wherein the service instruction is predetermined by the security device and the terminal device, or the service instruction is any one of a plural of service instructions predetermined by the security device and the terminal device.

9. The security device of claim 7, wherein the security device further comprising
a hardware clock module, which is connected to the control module and a cell module respectively, adapted to count time and realize the time protecting function of the security device; and
a cell module, which is connected to the hardware clock module, adapted to supply power to the hardware clock module when the security device is not connected to the terminal device.

10. The security device of claim 9, wherein the software protecting unit, adapted to protect the protected software of the terminal device via the preset time protecting function, comprises that the security device protects the protected software of the terminal device by the hardware clock module by using of the preset time protecting function.

11. The security device of claim 10, wherein the software protecting unit comprises
a reading sub-unit adapted to read current time of the hardware clock module;
a determining sub-unit, which is connected with the reading sub-unit, adapted to determine whether the current time is valid;
if the current time is valid, executing the service instruction and returning the executing result to the terminal device;
if the current time is not valid, returning the false result to the terminal device, or destroying the security device by itself internally, or locking the security device by itself automatically;
or
an activating sub-unit adapted to activate the hardware software module to start counting time;
a setting sub-unit, which is connected with the activating sub-unit, adapted to set the time status value of the hardware clock to the start time of the hardware time module;
a reading sub-unit, which is connected with the setting sub-unit, adapted to read the current time of the hardware clock module;
a determining sub-unit, which is connected with the reading sub-unit, adapted to determine whether the current time is valid;
if the current time is valid, executing the service instruction and returning the executing result to the terminal device;
if the current time is not valid, returning the false result to the terminal device, or destroying the security device by itself internally, or locking the security device by itself automatically.

12. The security device of claim 7, wherein the control module further comprises
a software clock unit adapted to count time and realize the time protecting function of the security device;
a waking unit, which is connected with the software clock unit, adapted to wake up the computing unit to start work over a time period;
a computing unit, which is connected with the software clock unit and the waking unit respectively, adapted to add the time period value to the value of time when the security device stops work to get a result and sets the result as the new current time of the security device.

13. The security device of claim 12, wherein the software protecting unit adapted to protect the protected software of the terminal device via the time protecting function comprises protecting, by the security device, the protected software of the terminal device by the software clock unit by using the preset time function.

14. The security device of claim 13, wherein the software protecting unit comprises
a reading sub-unit adapted to read the current time of the hardware clock module;
a determining sub-unit, which is connected with the reading sub-unit, adapted to determine whether the current time is valid;
if the current time is valid, executing the service instruction and returning the executing result to the terminal device;
if the current time is not valid, returning the false result to the terminal device, or destroying the security device by itself internally, or locking the security device by itself automatically; or
an activating sub-unit adapted to activate the hardware clock module to start counting time;
a setting sub-unit, which is connected with the activating sub-unit, adapted to set the time status value of the hardware clock module as the start time of the hardware clock module;
a reading sub-unit, which is connected with the setting sub-unit, adapted to determine whether the current time is valid;
if the current time is valid, executing the service instruction and returning the executing result to the terminal device;
if the current time is not valid, returning the false result to the terminal device, or destroying the security device by itself internally, or locking the security device by itself automatically.

15. The security device of claim 13, wherein the control module further comprises
a timer unit, which is connected with the software protecting unit, adapted to count time and realize the software protecting function of the security device.

16. The security device of claim 15, wherein the software protecting unit adapted to protect the protected software in the terminal device via the time protecting function comprises that the security device protects the protected software of the terminal device by the timer unit by using the preset time protecting function.

17. The security device of claim 15, wherein the software protecting unit comprises
an initializing sub-unit adapted to initialize and start the timer unit to start counting time;
a checking sub-unit, which is connected with the initializing sub-unit, adapted to check whether the timer unit reaches a threshold value when waiting for the terminal device to send command;
a determining sub-unit, which is connected with the checking sub-unit, adapted to determine the type of the received command sent by the terminal device;
a starting sub-unit, which is connected with the determining sub-unit, adapted to start function module if the determining sub-unit determines that the received command is Start command;
a calling sub-unit, which is connected with the determining sub-unit, adapted to call the function module when the determining sub-unit determines that the received command is Call command;
an ending sub-unit, which is connected with the determining sub-unit, adapted to end the using of the function module if the determining sub-unit determines that the received command is End command;
or,
a reading sub-unit, which is connected with the setting sub-unit and the storing sub-unit respectively, adapted to read the current time of the terminal device;
an initializing sub-unit, which is connected with the initializing sub-unit and the reading sub-unit respectively, adapted to set the current time of the terminal device, read by the reading sub-unit, to be the start time of the timer unit and the timer unit starts counting time;
a storing sub-unit, which is connected with the reading sub-unit, adapted to store the current time of the timer unit in the non-volatile storage chip when power is off;
a reading sub-unit, which is connected with the setting sub-unit, adapted to determine whether the current time is valid;
if the current time is valid, executing the service instruction and sending the executing result to the terminal device;
otherwise, returning the false result to the terminal device, or destroying the security device by itself internally, or locking the security device by itself automatically.
